(19) United States
(12) Patent Application Publication
(10) Pub. No.: US 2026/0355054 A1
(43) Pub. Date: Nov. 12, 2026

(54) METHOD OF TREATING URINARY FREQUENCY, URINARY URGENCY, AND NOCTURIA

(71) Applicants: Abraham Morgentaler, Sarasota, FL (US); Andre Danesh, Brookline, MA (US)

(72) Inventors: Abraham Morgentaler, Sarasota, FL (US); Andre Danesh, Brookline, MA (US)

(21) Appl. No.: 19/733,217

(22) Filed: Jul. 7, 2026

Related U.S. Application Data
(63) Continuation-in-part of application No. 17/227,226, filed on Apr. 9, 2021.

(51) Int. Cl. A61H 23/02

(52) U.S. Cl. CPC A61H 23/02; A61H 2201/0149; A61H 2205/087

(57) ABSTRACT

A process for treating non-bacterial or non-inflammatory urinary frequency, urinary urgency, or nocturia in a human male or female individual comprises the steps of: (a) placing a vibrator capable of generating vibration to the individual's perineum; (b) generating vibration through the perineum and into the person's adjacent pelvic substrates, including the pelvic floor, bladder neck, and trigone, and prostate (in men), and applying said vibration for a suitable period of time; and (c) repeating steps a and b for a suitable number of consecutive days to reduce urinary frequency, urinary urgency, or nocturia.

### CROSS-REFERENCE TO RELATED APPLICATION

This application is a continuation-in-part of co-pending U.S. patent application Ser. No. 17/227,226, filed Apr. 9, 2021, which is incorporated herein by reference in its entirety.

### FIELD OF THE INVENTION

The invention relates generally to the field of urology. More specifically, the invention relates to a method of treating the forms of urinary dysfunction known as urinary frequency, urinary urgency, and nocturia in males and females.

### BACKGROUND OF THE INVENTION

Bothersome urinary dysfunction is common in human males and females. In one study of individuals 41 years and older, 53% of men and 61% of women reported one or more urinary symptoms over a period of one month (Muscatello D J et al., Internal Med Journal, 2001, 31:151-160). In men, the most frequently reported urinary symptoms were urinary urgency and nocturia (awakening at night to urinate). In women, the most frequently cited urinary symptoms were stress incontinence (loss of urine with cough, sneeze, or straining) and urgency. For many affected individuals, these urinary dysfunctions can impair quality of life. Treatment of these symptoms has been shown to improve quality of life (Gacci M, et al., BJUI 2003, 91:196-200).

Men and women differ in their relevant anatomy for urination primarily by the presence of a prostate in men, yet they share many other key features. In both sexes, the bladder receives the urine produced by the kidneys via the ureters and serves as the reservoir for accumulated urine. When the bladder reaches a certain capacity, it sends a signal to the brain, and, if convenient, the individual begins the process of emptying the bladder via urination. In both sexes this occurs by relaxation of the pelvic floor musculature, relaxation of the urinary sphincter and bladder neck, and contraction of the detrusor muscle that lines the bladder wall. The pelvic floor, consisting of muscles, tendons, ligaments, and connective tissue, supports the bladder in both sexes, and also supports the prostate in men. In men, the urine first exits the bladder by coursing through the urethra through the middle of the prostate before passing through the non-prostatic portion of the urethra. In women, since no prostate is present, the urine passes directly from the bladder to the urethra. The trigone of the bladder, adjacent to the bladder neck in men and women, contains a rich network of sensory nerves that contribute to the feeling that an individual needs to urinate.

Benign enlargement of the prostate, called benign prostatic hyperplasia (BPH), is common, affecting 48% of men over 50 years of age as reported in one study (Naslund M J et al., Int J of Clin Pract 2007, 61:1437-1445). As the prostate enlarges, it may cause a well-established set of symptoms, termed lower urinary tract symptoms (LUTS), that include: nocturia, slow stream, frequency, urgency, hesitancy, incomplete emptying, and urinary retention. However, not all urinary dysfunctions in men are caused by enlargement of the prostate. Other contributing factors include pelvic floor dysfunction, inflammation, vascular disease, stress, bacterial infection, excess fluid intake, diabetes, heart failure, and neurologic conditions, as well as causes of obstruction such as stones, scar tissue, and strictures. The exact mechanisms by which aging itself contributes to urinary symptoms, such as nocturia and urinary frequency, are incompletely understood.

The primary treatment options for LUTS in men include surgical procedures by various methods to destroy the obstructive portions of prostate tissue, medications, behavioral treatments such as reduced fluid intake, and pelvic floor physiotherapy. Surgery is associated with risks of incontinence, altered sexual function, or bleeding and with a significant rate of re-operation. The two primary classes of medications used to treat male LUTS are alpha-adrenergic blockers and 5-alpha-reductase inhibitors. Risks of the former include syncope (loss of consciousness), reduced blood pressure, and reduced or absent ejaculatory volume with sexual activity. Risks of the latter include decreased libido, erectile dysfunction, and anorgasmia (inability to achieve orgasm). Compliance is generally poor with recommendations for reduced fluid intake and pelvic floor physiotherapy, and efficacy is limited.

In women, the primary treatments for urinary frequency, urinary urgency, and nocturia include: medications and Kegel or pelvic floor exercises to attempt to tighten the pelvic floor musculature. The most frequently used medications, called anticholinergics, are associated with dry mouth, malaise, confusion, and constipation.

Various attempts have been made to offer treatments for nocturia and daytime urinary frequency and urinary urgency. For example, Henley discloses in U.S. Patent Application Publication No. 20120143107 a device and method for treating nocturia that transmits a vibratory signal into the lumbar region of the back of a subject to stimulate the sacral nerve to mute a bladder control signal.

In another example, Dinsmoor discloses in U.S. Patent Application Publication No. 20200001090 a medical device system for treating urinary dysfunction in women, having an implantable medical device (IMD) coupled to at least one multi-electrode lead and configured to address a plurality of stimulation vectors, wherein the IMD and at least one multi-electrode lead are configured to provide sacral neuromodulation via placement of electrodes proximate to at least one location selected from the groups consisting of an S3 foramen and a ventral aspect of the S3 foramen. The medical device system also includes processing circuitry configured to provide pulse amplitudes and pulse widths consistent with a therapeutic regimen for treating urinary dysfunction. However, the disclosed techniques of electrode placement and implantation of neuromodulation devices are invasive and require the urologist to undergo specific training on the implantation material, the implantation technique, and parameterization of the pulse signals.

There is thus a clear need for a treatment for urinary frequency, urinary urgency, and nocturia in men and women that is safe, effective, non-invasive, and convenient and does not require involvement of trained medical personnel.

### OBJECTS OF THE INVENTION

It is an object of the invention to provide a method for treating urinary frequency, urinary urgency, or nocturia in an individual having urinary frequency, urinary urgency, or nocturia due to causes other than an acute infection or inflammation such as prostatitis, a urinary tract infection, or cystitis. This may be termed non-bacterial or non-inflammatory urinary frequency, urinary urgency, or nocturia. The method comprises the steps of:
a. applying a mechanical wave front generator, or vibrator, directly or through clothing to the individual's perineum, the vibrator being capable of generating a wave front, i.e., vibration, into and through said perineum;
b. generating the vibration and directing the vibration into and through said perineum and into the individual's adjacent pelvic structures, including the pelvic floor, bladder neck, and trigone, generation of the vibration continuing for at least 3 minutes; and
c. repeating steps a and b one or more times daily for a minimum of 3 consecutive days to reduce the frequency and/or severity of the individual's urination, i.e., to reduce the urinary frequency, urinary urgency, or nocturia.

It is also an object of the invention to provide a method for treating non-bacterial or non-inflammatory urinary frequency, urinary urgency, or nocturia in an individual wherein the vibration is applied continuously for a period of time varying between 3 and 30 minutes.

It is a further object of the invention to provide a method for treating non-bacterial or non-inflammatory urinary frequency, urinary urgency, or nocturia in an individual wherein the vibration is applied continuously for a period of time varying between 8 and 20 minutes.

It is a yet further object of the invention to provide a method for treating non-bacterial or non-inflammatory urinary frequency, urinary urgency, or nocturia in an individual wherein the method is repeated daily for from 4 to 30 consecutive days.

It is a yet further object of the invention to provide a method for treating non-bacterial or non-inflammatory urinary frequency, urinary urgency, or nocturia in an individual wherein the method is repeated daily for from 10 to 20 consecutive days.

It is a yet further object of the invention to provide a method for treating non-bacterial or non-inflammatory urinary frequency, urinary urgency, or nocturia in an individual wherein the vibration has a frequency of at least 10 Hertz.

It is a yet further object of the invention to provide a method for treating non-bacterial or non-inflammatory urinary frequency, urinary urgency, or nocturia in an individual wherein the vibration has a frequency that varies from 10 to 200 Hertz.

It is a yet further object of the invention to provide a method for treating non-bacterial or non-inflammatory urinary frequency, urinary urgency, or nocturia in an individual wherein the vibration has a frequency that varies from 20 to 100 Hertz.

It is a yet further object of the invention to provide a method for treating non-bacterial or non-inflammatory urinary frequency, urinary urgency, or nocturia in an individual wherein the individual is a male or female.

It is a yet further object of the invention to provide a method for treating non-bacterial or non-inflammatory urinary frequency, urinary urgency, or nocturia in an individual where the individual is preferably treated for urinary frequency or urinary urgency in the morning.

It is a yet further object of the invention to provide a method for treating nocturia in an individual having nocturia due to a cause other than acute infection or inflammation such as prostatitis, a urinary tract infection, or cystitis, that is, non-bacterial or non-inflammatory nocturia. The method comprises the steps of:
a. applying a mechanical wave front generator, or vibrator, directly or through clothing to the individual's perineum, the vibrator being capable of generating a wave front, i.e., vibration, into and through said perineum;
b. generating the vibration and directing the vibration into and through said perineum and into the individual's adjacent pelvic structures, including the pelvic floor, bladder neck, and trigone, generation of the vibration continuing for at least 3 minutes; and
c. repeating steps a and b one or more times daily for a minimum of 3 consecutive days to reduce the frequency and/or severity of the individual's nighttime urination, i.e., to reduce the nocturia.

It is a yet further object of the invention to provide a method for treating non-bacterial or non-inflammatory nocturia in an individual wherein the treatment is provided 4 hours or less before the individual retires for the night.

It is a yet further object of the invention to provide a method for treating non-bacterial or non-inflammatory urinary frequency, urinary urgency, or nocturia in a human male individual having non-bacterial or non-inflammatory urinary frequency, urinary urgency, or nocturia. The method comprises the steps of:
a. applying a vibrator directly or through clothing to the individual's perineum, the vibrator being capable of generating vibration into and through the perineum to the individual's prostate;
b. generating vibration and directing the vibration into and through said perineum, and into the individual's adjacent pelvic structures, including the individual's pelvic floor, bladder neck, trigone, and prostate, generation of the vibration continuing for at least 3 minutes; and
c. repeating steps a and b one or more times daily for a minimum of 3 consecutive days, wherein repetition of said steps is sufficient to reduce the frequency and/or severity of the patient's urination, i.e., to reduce the individual's urinary frequency, urinary urgency, or nocturia.

It is a yet further object of the invention to provide a method for treating non-bacterial or non-inflammatory urinary frequency, urinary urgency, or nocturia in an individual where the individual's International Prostate Symptom Score may be reduced by at least one category.

These and other objects of the invention will become more apparent from the discussion below.

### SUMMARY OF THE INVENTION

In one aspect of the invention, a method for treating non-bacterial or non-inflammatory urinary frequency, urinary urgency, or nocturia in an individual having non-bacterial or non-inflammatory urinary frequency, urinary urgency, or nocturia comprises the steps of:
a. applying a vibrator directly or through clothing to the individual's perineum, the vibrator being capable of generating vibration into and through said perineum;
b. generating vibration and directing the vibration into and through said perineum and into the individual's adjacent pelvic structures, including the pelvic floor, bladder neck, and trigone, generation of the vibration continuing for at least 3 minutes; and
c. repeating steps a and b one or more times daily for a minimum of 3 consecutive days to reduce the frequency and/or severity of the individual's daytime or nighttime urination, i.e., to reduce the individual's urinary frequency, urinary urgency, or nocturia.

In another aspect of the invention, in a method of treating non-bacterial or non-inflammatory urinary frequency, urinary urgency, or nocturia in an individual the vibration is applied continuously for a period of time varying between 3 and 30 minutes.

In a further aspect of the invention, in a method of treating non-bacterial or non-inflammatory urinary frequency, urinary urgency, or nocturia in an individual the vibration is applied continuously for a period of time varying between 8 and 20 minutes.

In a yet further aspect of the invention, in a method of treating non-bacterial or non-inflammatory urinary frequency, urinary urgency, or nocturia in an individual the method is repeated daily for from 4 to 30 consecutive days.

In a yet further aspect of the invention, in a method of treating non-bacterial or non-inflammatory urinary frequency, urinary urgency, or nocturia in an individual the method is repeated daily for from 10 to 20 consecutive days.

In a yet further aspect of the invention, in a method of treating non-bacterial or non-inflammatory urinary frequency, urinary urgency, or nocturia in an individual the vibrator has a frequency of at least 10 Hertz.

In a yet further aspect of the invention, in a method of treating non-bacterial or non-inflammatory urinary frequency, urinary urgency, or nocturia in an individual the vibration has a frequency that varies between 10 and 200 Hertz.

In a yet further aspect of the invention, in a method of treating non-bacterial or non-inflammatory urinary frequency, urinary urgency, or nocturia in an individual the vibration has a frequency that varies between 20 and 100 Hertz.

In a yet further aspect of the invention, there is a method for treating nocturia in an individual having nocturia due to a cause other than acute infection or inflammation such as prostatitis, a urinary tract infection, or cystitis, that is, non-bacterial or non-inflammatory nocturia. The method comprises the steps of:
a. applying a mechanical wave front generator, or vibrator, directly or through clothing to the individual's perineum, the vibrator being capable of generating a wave front, i.e., vibration, into and through said perineum;
b. generating the vibration and directing the vibration into and through said perineum and into the individual's adjacent pelvic structures, including the pelvic floor, bladder neck, and trigone, generation of the vibration continuing for at least 3 minutes; and
c. repeating steps a and b one or more times daily for a minimum of 3 consecutive days to reduce the frequency and/or severity of the individual's nighttime urination, i.e., to reduce the individual's nocturia.

In a yet further aspect of the invention, in a method of treating non-bacterial or non-inflammatory urinary frequency, urinary urgency, or nocturia in an individual the individual is a human male or female.

In a yet further aspect of the invention, in a method of treating non-bacterial or non-inflammatory urinary frequency, urinary urgency, or nocturia in an individual the method is performed within 4 hours or less of the individual retiring for the night.

In a yet further aspect of the invention, in a method for treating non-bacterial or non-inflammatory urinary frequency, urinary urgency, or nocturia in a human male individual having non-bacterial or non-inflammatory urinary frequency, urinary urgency, or nocturia, said method comprises the steps of:
a. applying a vibrator directly or through clothing to the individual's perineum, the vibrator being capable of generating vibration into and through the perineum to the individual's prostate;
b. generating the vibration and directing the vibration into and through the perineum and into the individual's adjacent pelvic structures, including the pelvic floor, bladder neck, trigone, and prostate, generation of the vibration continuing for at least 3 minutes; and
c. repeating steps a and b one or more times daily for a minimum of 3 consecutive days, wherein repetition of said steps is sufficient to reduce the frequency and/or severity of the individual's urination, i.e., to reduce the individuals'urinary frequency, urinary urgency, or nocturia.

It is a yet further aspect of the invention to provide a method for treating non-bacterial or non-inflammatory urinary frequency, urinary urgency, or nocturia in an individual where the individual's International Prostate Symptom Score may be reduced by at least one category.

### BRIEF DESCRIPTION OF THE DRAWINGS

FIG. 1 illustrates a cross-section of the male urogenital system the transducer component of a wave front generator or vibrator placed in contact with the perineum.

FIG. 2 illustrates a cross-section of the female urogenital system, with the transducer component of a wave front generator or vibrator placed in contact with the perineum.

FIG. 3 illustrates an embodiment of a wave front generator or vibrator comprising a chair with a built-in transducer and a controller connected to the transducer.

### DETAILED DESCRIPTION OF THE INVENTION

As used, the term “perineum” defines the space between the anus and the base of the scrotum in the male, and between the anus and the inferior edge of the vagina in the female. The “urogenital triangle” is approximately an isosceles triangle comprising, in men, the space between the anus and the base of the scrotum, wherein the apex of the triangle is at the base of the scrotum and the base of the triangle is at the edge of the anal opening. The anatomy is similar in females, replacing the base of the scrotum with the inferior edge of the vagina.

The process of the subject invention is a method for treating urinary frequency, urinary urgency, and nocturia in an individual comprising the steps of: (a) placing the transducer component of a wave front generator or vibrator in contact with the individual's perineum; (b) continuously generating vibration directed towards and into the individual's perineum and into adjacent pelvic structures, which may include the individual's pelvic floor, bladder neck, trigone, and prostate (in males), for a suitable period of time; and (c) repeating steps (a) and (b) for a suitable number of consecutive days.

Wave front generators or vibrators are well known in the art. They typically comprise a controller, a motor, and a transducer. The controller and the motor/transducer assembly may be a single integrated device, or the controller may be separated from the motor/transducer assembly. The controller regulates the motor by controlling the on/off state and modulating the frequency and/or amplitude of the vibration generated by the motor. The motor is directly coupled to the transducer, which contacts the body and transmits the vibratory stimulation to the individual. Wave front generators or vibrators typically have controls that enable generation of vibration within a wide range of frequencies ranging from extremely low frequency (ELF—the ITU designation) with frequencies of from 3 to 30 Hz, up to high frequencies in excess of 10,000 MHz. The wave front generator or vibrator used in the process of the subject invention is one that would operate at the lower frequencies. The preferred wave front generator or vibrator is one that generates vibrations as will be discussed in greater detail below.

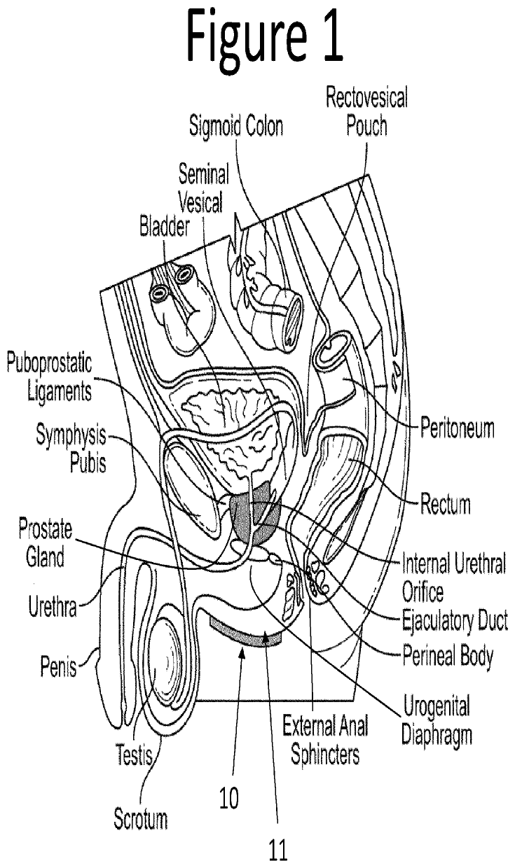

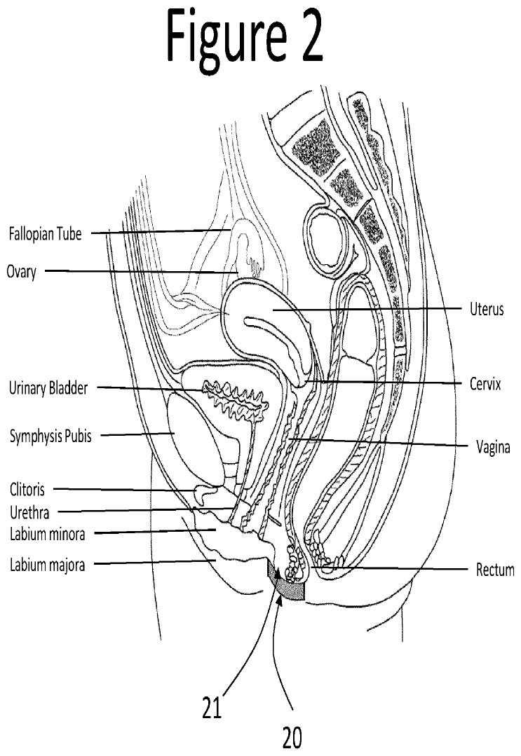

The placement of the wave front generator or vibrator relative to the perineum is illustrated in FIGS. 1 and 2 of the drawings. In FIG. 1, illustrating the use of the process of the invention for treatment of urinary frequency, urinary urgency, or nocturia in a male, a transducer 10 is located in proximity to perineum 11. Similarly, FIG. 2 illustrates the process of the invention for treatment of urinary frequency, urinary urgency, or nocturia in a female, where transducer 20 is located adjacent to or contacting perineum 21.

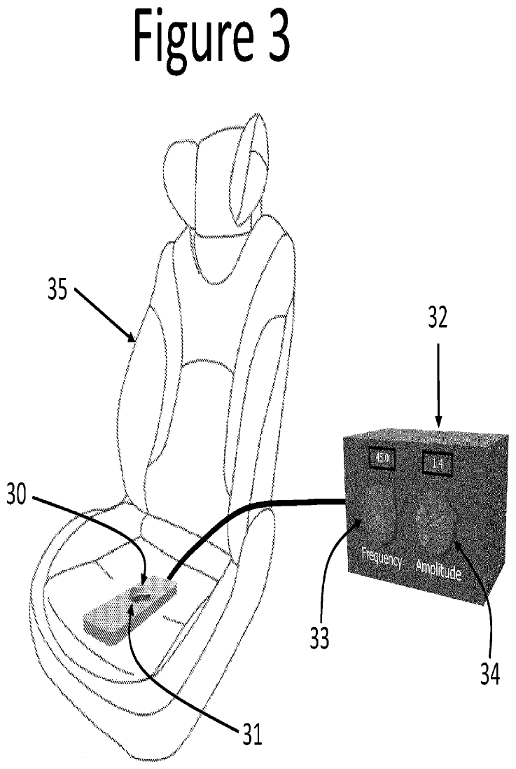

FIG. 3 illustrates one embodiment of a suitable wave front generator or vibrator for use in the process of the invention. In the embodiment shown, apparatus 30 comprises a truncated vertex vibrator 31, configured on chair 35, for placement in proximity of the pelvic floor of a user, with wave front generator or vibrator 30, coupled to controller 32, having control 33 to adjust frequency, and control 34 to adjust wave amplitude.

The use of vibration to treat urinary frequency, urinary urgency, or nocturia in accordance with the invention employs various parameters such as duration of time during which the wave front is passed through the perineum per use, the number of times the process is practiced daily or within a given period of time, wave frequency, and, to a lesser extent, wave characteristics such as wave amplitude and shape. Preferred ranges for the more significant parameters are given below.

In practice of the process of the invention, the wave front frequency may be as low as 5 Hertz or in excess of 200 Hertz to achieve some relief of urinary frequency, urinary urgency, or nocturia. A preferred range is from 10 to 200 Hertz, a more preferred range is from 20 to 100 Hertz, and a most preferred range is from 20 to 60 Hertz. The duration of time during which vibration is generated per use may vary between 3 and 30 consecutive minutes, but more preferably varies between 5 or 8 and 20 consecutive minutes. The number of consecutive days of use of the wave generator may be as few as 3 for temporary relief, or the wave generator may be used daily over an extended period of time without limit. Preferably, for satisfactory results, the number of days varies between 4 and 30 days, and more preferably, between 10 and 20 days. The wave front generator or vibrator may be used more often than once daily. Wave amplitude may vary between 0.005 and 10 mm. To target nocturia, the treatment is ideally performed within 4 hours of the user retiring for the night. To target daytime urinary frequency and urinary urgency, treatment may be more beneficial in the morning. These observations regarding time of day of treatment are recommendations but are not required, since some individuals will respond well regardless of time of day of usage.

The parameters given above are, to some extent, interrelated. For example, if the vibrator is used less than twice daily, it may take a longer time to achieve beneficial results. It should also be understood that the severity of symptoms vary widely between individuals, so that one individual with severe symptoms may require longer treatment regimens than someone with milder symptoms. Also, the degree of “bother” can vary between individuals with the same degree of symptoms, such that one individual who awakens twice per night to urinate may feel this is a satisfactory result, whereas another may find this same degree of nocturia urinary frequency, for example, to be distressing.

In addition, using the process of the invention, improvement in the degree of urinary frequency, urinary urgency, or nocturia may take place gradually over an extended period of time. For some individuals, improvement may begin within a few days, whereas, for others, it may take longer. Likewise, satisfactory relief of urinary frequency, urinary urgency, or nocturia may occur with fewer continuous days of use for some individuals than for others, and more days of continuous use may be required to achieve similar results.

It should also be understood that the ranges for treatment parameters given are generalized for an average individual. However, different individuals may require differing use parameters due to individual variation in anatomy and physiology.

There are methods to measure the frequency and/or severity of urinary frequency, urinary urgency, or nocturia. One such method is The International Prostate Symptom Score (IPSS). This scoring protocol involves providing an individual with a patient questionnaire that includes a Quality of Life Scale at the end of the questionnaire. Symptom scores are based upon the number of times a patient answers “yes” to any of the questions within the questionnaire. The questionnaire ranks symptoms by categories, mild, moderate and severe. A range of from 0 to 7 represents mild symptoms, 8 to 19 represents moderate symptoms, and 20 to 35 represents severe symptoms.

In a preferred embodiment of the invention, a vibrator is used as a mechanical wave front generator. Vibrators are commercially available. They may comprise a motor, a controller, and a separate transducer or may be a single handheld instrument. As is known in the art, vibrators may generate vibrations using motor driven reciprocating pistons or other objects, eccentric weights driven by a conventional electric motor, or employing magneto-mechanical forces comprising electromagnet coils actuated by an alternating current signal, and further comprising magnetic metals. The vibrator may run on batteries or plug into a conventional wall socket. Further, the vibrator may use the flow of air or other gaseous or liquid fluid from a pump, employing either vacuum or positive pressure to generate the mechanical wave. And yet further, the vibrator may be a piezoelectric device, an electro strictive device, or an electroacoustic transducer, comprising a magnet, a function coil, a diaphragm, optionally, a suspension, and, optionally, a cooler.

The wave front generator or vibrator may be placed on a seat or incorporated into and/or upon the seat of a comfortable chair as shown in FIG. 3 of the drawings or embedded in a comfortable cushion or bench or other sitting, kneeling, reclining or even standing position. Alternatively, the vibrator may be handheld or positioned in or on any furniture or apparatus in which the vibrator can be applied to the patient's perineal area, either directly or through clothing. Moreover, the transducer may have a variety of shapes and sizes to address the specific target location and fit comfortably into the desired anatomical space. These include triangular shapes, quadrilateral shapes, trapezoidal shapes, parallelogram shapes, rectangular, square shapes, round shapes, oval shapes, or elliptical shapes. The transducer may be generally flat, generally concave, or generally convex at the locus of contact to provide the necessary comfort and therapeutic efficacy. The device may further include a controller providing controls for amplitude, frequency, waveform and other similar parameters. In addition, the wave energy generator or vibrator may have additional controls such as for heating and cooling.

Directing energy via a wave front may further include applying a triangular transducer having an area of contact along at least a portion of the length of the perineum, wherein the base of the triangle is adjacent to the anus, and wherein the width of the base of the triangle is between about 0.5 cm and about 6 cm. Various sizes and shapes of transducers may be contemplated to accommodate anatomical differences between individuals.

In the following examples, The International Prostate Symptom Score (IPSS) was used to evaluate results.

### EXAMPLES

Example 1: A 71-year old male subject applied a commercially available vibrator to deliver vibration at a frequency of 55 Hertz to the surface of his perineum. It was initially used for 5 minutes, and then after 9 days, for 7 minutes, within 4 hours prior to bed time. Prior to treatment, his The International Prostate Symptom Score (IPSS) was 12 out of a possible score of 35 (high numbers indicate greater severity of symptoms). After two days of treatment his IPSS score had dropped to 5, and by the next day the IPSS score was 2. By day 10 the IPSS score was 1. This amounts to an improvement of 11 points. For context, a decrease of 3 points in an individual is considered clinically meaningful, and mean IPSS score improvement with standard medical therapy using alpha blocker medications such as tamsulosin or alfuzosin is 5-6 points.
Example 2: An 87-year-old man with longstanding symptoms of bothersome nocturia, three or four times each night, used the same vibratory stimulus to the perineum twice daily, in the morning and before bedtime, for five to seven minutes at a time. Within several days he noted reduced nocturia, and after a week he awakened to urinate only once. He continued with greatly reduced nocturia, 1-2 times per night, after 3 months of using the device, which he eventually used once daily, just before bedtime. His sleep was improved, and he felt more refreshed during the day.

Various changes and modifications obvious to persons skilled in the art to which the invention pertains are deemed to lie within the spirit, scope and contemplation of the subject matter set forth in the appended claims.

What is claimed is:

1. A method for treating non-bacterial or non-inflammatory urinary frequency, urinary urgency, or nocturia in an individual said method comprising the steps of:
a. applying a vibrator directly or through clothing to the individual's perineum, the vibrator being capable of generating vibration into and through said perineum;
b. generating the vibration and directing the vibration into and through said perineum and into the individual's adjacent pelvic substrates, including the pelvic floor, bladder neck, and trigone, generation of said vibration continuing for at least 3 minutes; and
c. repeating steps a and b one or more times daily for a minimum of 3 consecutive days to reduce the frequency and/or severity of the individual's urinary frequency, urinary urgency, or nocturia.

2. The method of claim 1, wherein the vibration is applied continuously for a period of time varying between 3 and 30 minutes.

3. The method of claim 1, wherein the method is repeated daily for from 4 to 30 consecutive days.

4. The method of claim 1, wherein the vibration has a frequency of at least 10 Hertz.

5. The method of claim 4, wherein the vibration has a frequency that varies from 10 to 200 Hertz.

6. The method of claim 1, wherein the individual is a human male or female.

7. A method for treating non-bacterial or non-inflammatory urinary frequency, urinary urgency, or nocturia in a human male individual, said method comprising the steps of:
a. applying a vibrator directly or through clothing to the individual's perineum, the vibrator being capable of generating vibration into and through the perineum to the individual's prostate;
b. generating the vibration and directing the vibration into and through said perineum, and into the individual's adjacent pelvic structures, including the individual's pelvic floor, bladder neck, trigone, and prostate, generation of the vibration continuing for at least 3 minutes; and
c. repeating steps a and b one or more times daily for a minimum of 3 consecutive days, wherein repetition of said steps is sufficient to reduce the frequency and/or severity of the individual's urinary frequency, urinary urgency, or nocturia.

8. The method of claim 7, wherein the vibration is applied continuously for a period of time varying between 3 and 30 minutes.

9. The method of claim 7, wherein the method is repeated daily for from 4 to 30 consecutive days.

10. The method of claim 7, wherein the method is performed within 4 hours or less of the patient retiring for the night.

11. The method of claim 7, wherein the vibration has a frequency of at least 10 Hertz.

12. The method of claim 11, wherein the vibration has a frequency that varies from 10 to 200 Hertz.

13. The method of claim 7, where the individual's International Prostate Symptom Score is reduced by at least one category.

14. A method for treating non-bacterial or non-inflammatory nocturia in an individual, said method comprising the steps of:
a. applying a vibrator directly or through clothing to the individual's perineum, the vibrator being capable of generating vibration into and through said perineum;
b. generating the vibration and directing the vibration into and through said perineum and into the individual's adjacent pelvic substrates, including the pelvic floor, bladder neck, and trigone, generation of said vibration continuing for at least 3 minutes; and
c. repeating steps a and b one or more times daily for a minimum of 3 consecutive days to reduce the frequency and/or severity of the individual's nighttime urination.

15. The method of claim 14, wherein the individual is a human male or female patient.

16. The method of claim 14, wherein the method is performed within 4 hours or less of the individual retiring for the night.
